(19) United States
(12) Patent Application Publication
(10) Pub. No.: US 2005/0105842 A1
(43) Pub. Date: May 19, 2005

(54) Integrated optical arrangement

(76) Inventors: Adrian Petru Vonsovici, London (GB); Haydn Jones, Abingdon (GB)

Correspondence Address: FLESHNER & KIM, LLP, P.O. Box 221200, Chantilly, VA, 20153-1200, US

(21) Appl. No.: 10/326,283

(22) Filed: Dec. 23, 2002

(30) Foreign Application Priority Data
Dec. 27, 2001 (GB) 0131005.1

(51) Int. Cl. G02B 6/12

(52) U.S. Cl. 385/14

(57) ABSTRACT

An integrated optical arrangement for reducing or preventing the transmission of unwanted or stray light within an optical substrate, the device comprising trenches formed in the substrate for deflecting said light from one area of the substrate to one or more selected regions in another area of the substrate, these region(s) comprising a light trap and/or an absorptive region so as to prevent the majority of the light received thereby from escaping therefrom.

This invention relates to an integrated optical arrangement for reducing or preventing the transmission of unwanted or stray light within an optical substrate.

A common problem with integrated optical devices is the presence of stray light in the substrate in which the optical components of the device are formed. Although most of the light is guided by the waveguides, some light inevitably escapes into the surrounding substrate, e.g. where light is input into an end of a waveguide or where light leaves the end of a waveguide or due to leakage of light from the waveguide, e.g. around bends in the waveguide or at junctions between waveguides. Such stray light can cause cross-talk between waveguides or may reach light detectors provided on the device. In either case, it reduces the signal/noise ratio for the device.

It is known to use doped areas to absorb stray light as described in U.S. Pat. No. 6,298,178. However, in many cases it is desired to minimise the area of doped regions provided on a device as they can give rise to heating of the chip during processing, which, in turn, can lead to distortion of the chip. It is also desired to minimise the area of doped regions positioned close to devices such as waveguides as they attenuate a portion of the optical signal extending beyond the confines of the waveguide.

The present invention aims to provide an improved arrangement for reducing or preventing the transmission of unwanted or stray light from one area of a device to another.

According to a first aspect of the invention, there is provided an integrated optical arrangement for reducing or preventing the transmission of unwanted or stray light within an optical substrate, the device comprising one or more trenches formed in the substrate for deflecting said light from one area of the substrate to one or more regions in another area of the substrate, said region(s) being adapted to prevent at least the majority of the light received thereby from escaping therefrom.

Preferred and optional features of the invention will be apparent from the following description and the subsidiary claims of the specifications.

The invention will now be further described, merely by way of example, with reference to the accompanying drawings, in which:

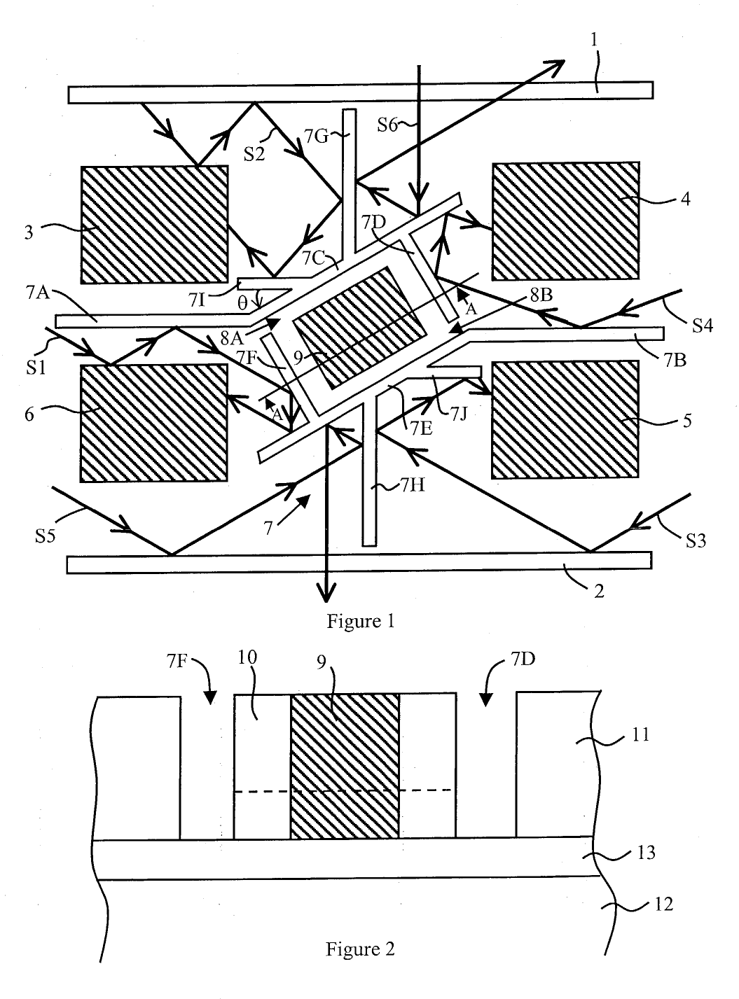

FIG. 1 is a schematic plan view of a first embodiment of the invention;

FIG. 2 is a cross-section taken on line A-A in FIG. 1,

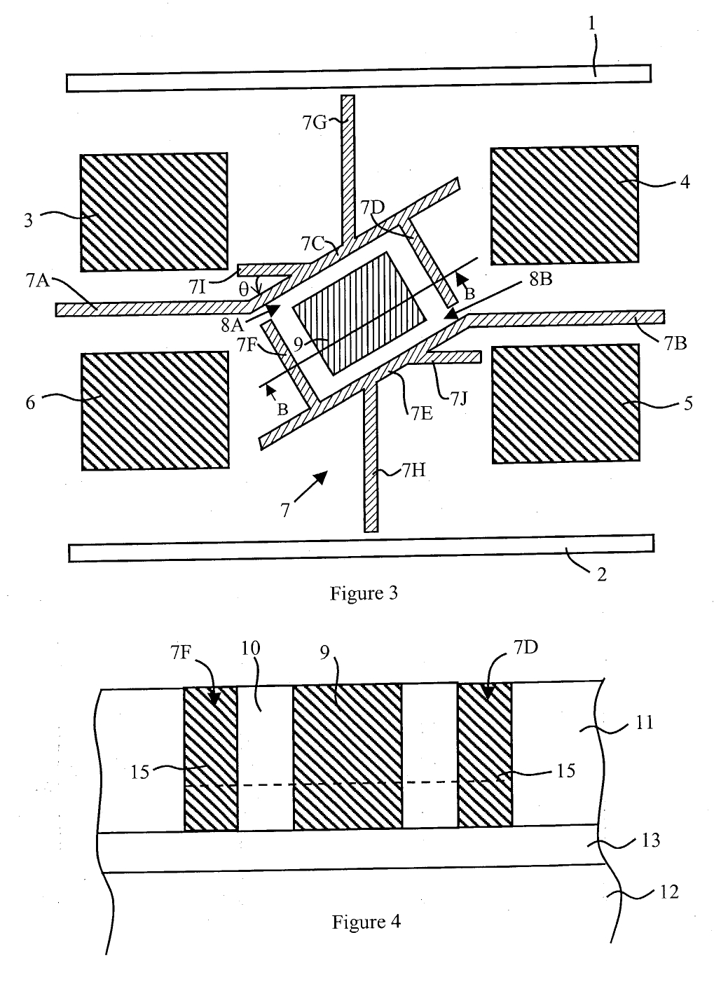

FIG. 3 is a schematic plan view of a second embodiment of the invention;

FIG. 4 is a cross-section taken on line B-B of FIG. 3;

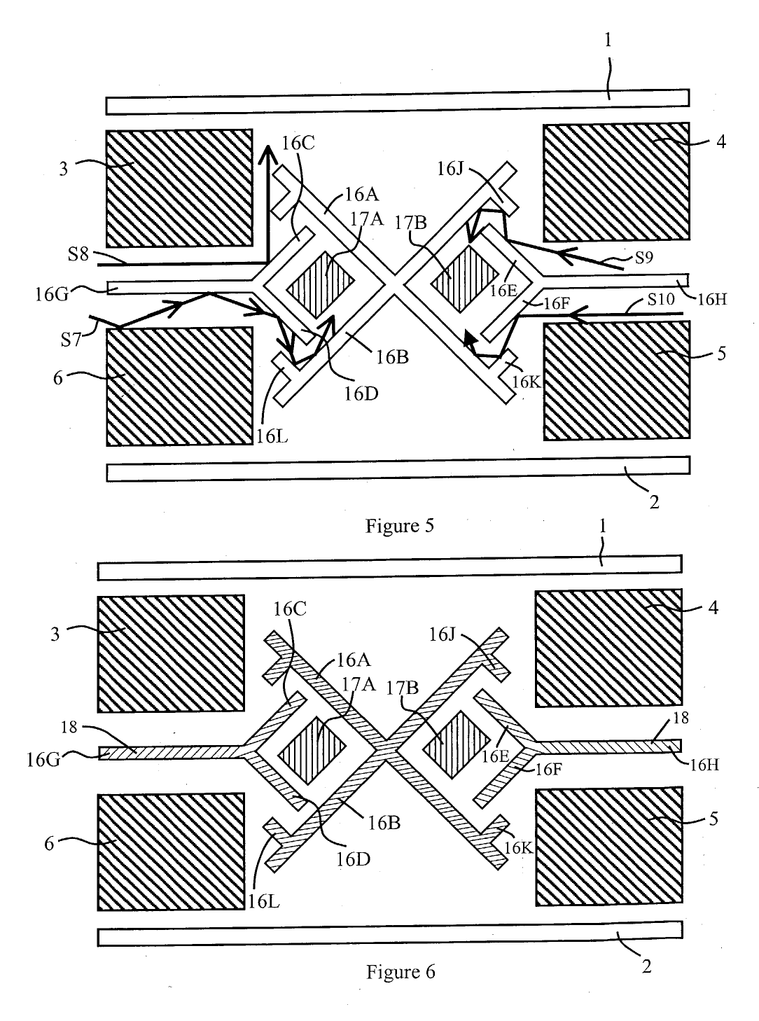

FIG. 5 is a schematic plan view of a third embodiment of the invention;

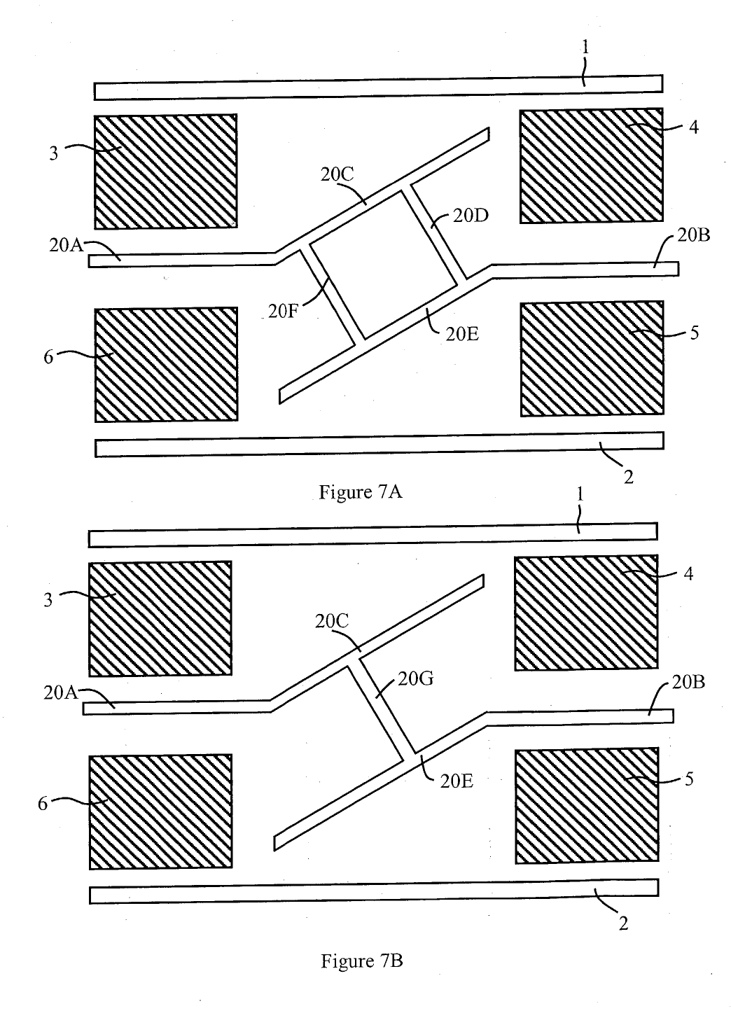

FIG. 6 is a schematic plan view of a fourth embodiment of the invention;

FIGS. 7A and B are a schematic plan views of fifth and sixth embodiments of the invention; and

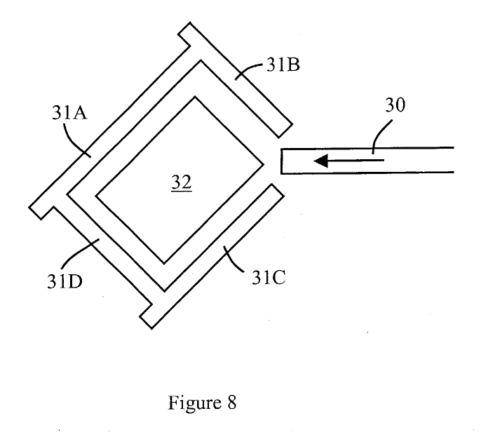

FIG. 8 is a schematic plan view of a seventh embodiment of the invention.

FIG. 1 shows a pair of waveguide channels 1 and 2 and doped regions 3, 4, 5 and 6, e.g. of p-i-n diodes or attenuators formed across the waveguides 1, 2 (further doped regions would be provided opposite these on the other side of the waveguides but are not shown) schematically illustrated by rectangular regions. Between these components a pattern of trenches 7 is formed to provide optical isolation between the two waveguides 1, 2 and between the respective doped regions 3, 4, 5 and 6. In the arrangement shown, the pattern of trenches 7 comprises: trenches 7A and 7B substantially parallel to the waveguides 1 and 2, a rectangular pattern formed by trenches 7C, 7D, 7E and 7F, trenches 7G and 7H extending from said rectangular pattern towards the respective waveguides 1 and 2 in a direction perpendicular to the waveguide axes and two trenches 7I and 7J extending from sides of the rectangular pattern towards doped regions 3 and 5 in a direction parallel to the waveguides 1 and 2. As shown, the rectangular pattern is at an angle relative to the waveguides 1 and 2 and extends between the trenches 7A and 7B. The angle between a side of the rectangular pattern and the waveguide axes, as represented by the angle between trenches 7C and 7I is preferably in the range 45 to 60 degrees.

The majority of the stray light in the substrate between parallel waveguides travels substantially parallel to the waveguides. The trenches are thus preferably angled with respect to this light so as to avoid simply reflecting it back in the opposite direction.

The pattern of trenches 7 is arranged so as to deflect stray light within the plane of the substrate between the waveguides 1 and 2 and doped regions 3, 4, 5 and 6 into one or more regions from which the light cannot escape. In particular, the majority of light entering the rectangular pattern formed by trenches 7C, 7D, 7E and 7F (through a gap 8A between trenches 7F and 7C or a gap 8B between trenches 7D and 7E) is trapped therein as the sides of the rectangle deflect light back into the substrate within the rectangle.

In a preferred arrangement, a light absorbent region 9 may be provided in the centre of the rectangular pattern. This arrangement maximises the efficiency of the light absorbed as light is repeatedly directed towards the region 9 it until the light is all absorbed. However, in some cases, this is not required or may be undesirable and the light is trapped merely by the fact that it is repeatedly reflected around the inside of the rectangular pattern (only a very small portion being able to escape back out of the gaps 8A and 8B). In practice, this light is gradually attenuated by the repeated reflection.

In addition, the arrangement of trenches projecting from the exterior of the rectangular pattern is such as to deflect stray light incident thereon towards one of the doped regions 3, 4, 5 or 6. For instance, stray light indicated by arrow S1 will be deflected by one or more of trenches 7A, 7F and 7E back towards the doped region 6 where it is absorbed. Thus, in this embodiment, the doped regions 3, 4, 5 and 6 perform two functions: they form part of a device such as a p-i-n diode and they act as light absorbers for stray light which is deflected towards them by the pattern of trenches 7.

Arrows S2, S3 and S4 similarly indicate how stray light from other directions is deflected towards a doped region where it is absorbed. Arrows S5 and also S6 illustrate how light from some directions is deflected sideways (so that it is absorbed in other doped regions (not shown) or at least is prevented from reaching the output of the device, e.g. light sensors at the ends of the waveguides 1,2).

It will be seen that the trenches 7 are arranged so as, in effect, to channel the majority of light within the substrate whose direction of travel has a component parallel to the waveguides towards either a light trap or light absorptive region by repeated reflection from the side walls of channels formed by the trenches and other components of the optical device.

It will be appreciated that the rectangle of trenches 7C, 7D, 7E, 7F, together with trenches 7G and 7H also substantially block transmission of light travelling parallel to the waveguides 1 and 2, e.g. from the areas around doped regions 3 and 6 to areas around the doped regions 4 and 5. Similarly, the rectangle of trenches 7C, 7D, 7E, 7F, together with trenches 7A and 7B, substantially block transmission of light from one waveguide towards the other, e.g. from the areas around doped regions 3 and 4 to areas around the doped regions 5 and 6.

Trenches 7I and 7J help ensure that stray light such as S2 and S3 is deflected towards the doped regions 3 and 5 rather than passing around the doped regions. Also, the acute angle θ within the V-shape formed between trenches 7I and 7C (and trenches 7E and 7J) serves as a light trap as stray light entering the V-shape is deflected further and further into the V.

FIG. 2 shows a cross-section on line A-A of FIG. 1. The device is preferably formed in a silicon substrate and this is most preferably in the form of a silicon-on-insulator chip comprising an optically conducting silicon layer 11, separated from a supporting substrate 12 (typically also of silicon) by a light confining layer 13, e.g. of silicon dioxide.

In one possible arrangement, the region 10 of substrate between the trenches 7C, 7D, 7E and 7F is simply a region of substrate similar to that outside the rectangular pattern. However, as mentioned above, in a preferred arrangement, a light absorber 9 may be provided in the region 10, e.g. in the form of a doped region. The region 10 and doped region 9 therein may be of similar height (perpendicular to the plan of the substrate on which the device is formed) to the regions of substrate outside the rectangular pattern. However, the height of these regions 9 and 10 may be reduced as shown by the dashed line in FIG. 2. This can make it easier to form a doped region 9 through the depth of the substrate 10 to the underlying oxide layer 13.

FIG. 3 is a schematic plan view of a second embodiment of the invention. This is similar to the first embodiment except that light absorbent material 15 is provided in the trenches as indicated by the hatched shading. A light absorbent region 9 is again shown within the region surrounded by the trenches 7C, 7D, 7E and 7F. However, as in the first embodiment, this is optional as in some cases it is not required or may be undesirable (due to it complicating the fabrication processes further).

FIG. 4 is a cross-section taken on line B-B of FIG. 3. The light absorbent material 15 in the trenches is preferably the same as that provided in region 9 and may, for example, comprise doped areas of the silicon layer 11. Other forms of light absorbent material may be used (as will be described further below).

Amorphous or polycrystalline regions may, for instance, be used to absorb light. Amorphous silicon has an absorption coefficient approximately 40 times that of crystalline silicon. The amorphous or polycrystalline region may also be doped if required.

A further possibility is to use metal layers to absorb the light, e.g. by providing a metal coating, e.g. of aluminium, in the region 9 and/or at the bottom of the trenches. If a metal coating is used in the region 9 this may be applied to the base of a recess formed in that area or on the upper surface of the silicon layer 11 in that area.

FIG. 5 is a schematic plan view of a third embodiment of the invention using a different pattern of trenches between the waveguides 1 and 2 and the doped regions 3, 4, 5 and 6. In this case, the pattern of trenches comprises: two trenches 16A and 16B in an X-pattern between the waveguides, trenches 16C and 16D which form a first rectangular shape with one side of the X-pattern, trenches 16E and 16F which form a second rectangular shape with the opposite side of the X-pattern, trenches 16G and 16H extending from the respective rectangular shapes parallel to the waveguides and short trenches 16I, 16J, 16K and 16L towards the ends of each of the arms of the X-pattern and at right angles thereto. Optical light absorbing regions 17A and 17B are preferably provided within the first and second rectangular shapes.

The pattern of trenches shown in FIG. 5 is again designed to deflect stray light either into a light trap as formed by the first and second rectangular patterns or into the doped regions 3, 4, 5 or 6. This is illustrated by arrows S7 to S10. The pattern of trenches also optically isolates the two waveguides 1 and 2 from each other and optically isolates the areas around each of the doped regions from each other.

FIG. 6 is a schematic plan view of a fourth embodiment of the invention. This is similar to the third embodiment except that light absorbent material 18 is provided in the trenches (in a similar manner to that described in relation to FIGS. 2, 3 and 4) as shown by the hatched shading.

FIG. 7A is a schematic plan view of a fifth embodiment of the invention with yet another pattern of trenches between waveguides 1 and 2 and doped regions 3, 4, 5 and 6. This pattern comprises trenches similar to some of those shown in FIG. 1, in that it comprises trenches 20A and 20B parallel to the waveguides and trenches 20C, 20D, 20E and 20F therebetween in a rectangular pattern. In the illustrated example, this rectangular pattern does not comprise gaps corresponding to gaps 8A and 8F of FIG. 1 (although these can be present in a further variation). The illustrated arrangement of trenches thus acts to deflect stray light towards the doped regions 3, 4, 5 and 6 and the rectangular pattern of trenches does not act as a light trap. However, as mentioned, gaps may be provided in one or more locations in the square pattern of trenches so that it also acts as a light trap.

FIG. 7B shows another arrangement similar to that of FIG. 7B but with trenches 20D and 20F replaced by a single trench 20G.

FIG. 8 is a schematic plan view of a seventh embodiment of the invention. In this embodiment, a pattern of trenches is used to form a light trap and the light trap is arranged to receive light from a waveguide 30. The light trap is thus used as a beam dump. The light trap comprises a rectangular pattern of trenches 31A, 31B, 31C and 31D with an absorptive region 32 in the substrate within the area surrounded by the trenches. Light from the waveguide 30 is thus repeatedly reflected around the region within the trap by the trenches and thus repeatedly directed through the absorptive region until all the light is absorbed.

It will be appreciated that in each of the arrangements described above, an arrangement of trenches as provided which deflects light into an absorptive region or into a light trap from which it cannot escape. The arrangements shown in FIGS. 1-7 are designed to absorb or trap stray light in the substrate of an integrated optical device from a variety of directions. Whilst such a device is well-suited to use between two waveguides as shown, it can be used in other positions on an integrated optical circuit. The doped regions 3, 4, 5 and 6 described are also just examples of components between which the light absorber/trapper can be provided. These regions may be substituted by a wide range of other passive or active devices comprising doped or other absorptive regions.

The arrangement shown in FIG. 8 operates in a similar manner but is designed to absorb light received from only one direction (although other waveguides could also direct light into the light trap through additional gaps provided between the trenches surrounding the light absorption region).

It will also be appreciated that the use of trenches to provide optical isolation, avoids or reduces the area of doped regions formed on the substrate. This is important in applications where it is desired to minimise the thermal load on the device during its fabrication. In addition, the trenches provide electrical isolation as well as optical isolation.

The devices described comprise a simple arrangement of trenches and, optionally, absorptive regions such as doped regions. These can easily be fabricated during the manufacture of the integrated circuit in which they are provided. Indeed, in some cases, this can be done without additional process steps: the trenches can be formed by the same lithographic steps used to form other features (such as waveguides) of the circuit and the absorptive region can be formed by the same fabrication steps used to form other doped regions, e.g. the doped regions of p-i-n diodes, used in the circuit.

As shown, the trenches are preferably straight, parallel sided and extend down to the oxide layer, their sides being perpendicular to the plane of the chip (as shown in FIGS. 2 and 4). The trenches would typically have a width in the range of 3 to 15 microns. However, other forms of trenches may be used so long as they function to deflect light from the desired source towards an absorptive region and/or into a light trap.

1. An integrated optical arrangement for reducing or preventing the transmission of unwanted or stray light within an optical substrate, the device comprising one or more trenches formed in the substrate for deflecting said light from one area of the substrate to one or more selected regions in another area of the substrate, said region(s) being adapted to prevent at least the majority of the light received thereby from escaping therefrom.

2. An arrangement as claimed in claim 1 in which at least one of said regions is surrounded by confinement trenches arranged to confine at least a substantial portion of said light within the region by deflecting light back into said region.

3. An arrangement as claimed in claim 1 in which said one or more selected regions comprises an absorptive region.

4. An arrangement as claimed in claim 2 in which the light absorbing means is provide in a portion of the substrate within said at least one region substantially surrounded by said trenches.

5. An arrangement as claimed in claim 4 in which the light absorbing means comprises a doped region, an amorphous region, a polycrystalline region, a metallic region or any combination thereof.

6. An arrangement as claimed in claim 2 comprising four trenches arranged in a generally rectangular pattern with gaps between the trenches at or adjacent one or more corners of the rectangle.

7. An arrangement as claimed in claim 1 provided between or adjacent optical components of an integrated optical circuit.

8. An arrangement as claimed in claim 7 provided between a pair of waveguides.

9. An arrangement as claimed in claim 8 which provides optical isolation between a pair of waveguides.

10. An arrangement as claimed in claim 3 in which a plurality of absorptive regions are provided in the substrate and the trenches arranged to deflect stray light in the substrate towards one or more of the absorptive regions.

11. An arrangement as claimed in claim 3 in which the or one or more of the absorptive regions also performs some other function or is part of another optical component provided on the substrate.

12. An arrangement as claimed in claim 11 in which the absorptive region is a doped region which also forms part of a p-i-n diode.

13. An arrangement as claimed in claim 1 in which said one or more trenches together with other components in the substrate form one or more channels for leading stray light towards one or more of said selected regions by repeated reflection.

14. An arrangement as claimed in claim 13 in which said other components comprise one or more absorptive regions.

15. An arrangement as claimed in claim 14 in which said one or more absorptive regions also form one of more of said selected regions.

16. An arrangement as claimed in claim 8 in which a plurality of trenches are provided in a substantially rectangular pattern the sides of the rectangle being inclined to the axes of the waveguides.

17. An arrangement as claimed in claim 8 in which one or more of the trenches are inclined to the axes of the waveguides.

18. An arrangement as claimed in claim 16 in which further trenches are provided extending from said rectangular pattern substantially parallel to and/or perpendicular to the axes of the waveguides.

19. An arrangement as claimed in claim 1 provided at or adjacent the end of a waveguide so as to receive light therefrom.

20. An arrangement as claimed in claim 1 in which light absorbing material is provided in one or more of the trenches.
